(19) United States
(12) Patent Application Publication
(10) Pub. No.: US 2023/0177639 A1
(43) Pub. Date: Jun. 8, 2023

(54) TEMPORAL VIDEO ENHANCEMENT

(71) Applicant: Black Sesame Technologies Inc., San Jose, CA (US)

(72) Inventors: Evelyn Chee, Singapore (SG); Yubo Duan, Singapore (SG); Shanlan Shen, Singapore (SG)

(21) Appl. No.: 17/545,424

(22) Filed: Dec. 8, 2021

(51) Int. Cl. G06T 3/40; G06T 5/50

(52) U.S. Cl. CPC G06T 3/4046; G06T 5/50; G06T 2207/20016; G06T 2207/20221; G06T 2207/10016

(57) ABSTRACT

A method of age and gender estimation, comprising receiving an input image, detecting a facial image within the input image, estimating a head pose based on a set of facial image intensities of the facial image, Wherein the head pose is expressed as a yaw, a pitch and a roll, determining whether the yaw, the pitch and the roll of the head pose is less than a predetermined threshold, aligning the facial image if the yaw, the pitch and the roll of the head pose are less than the predetermined threshold and predicting an age and a gender of the aligned facial image.

### BACKGROUND

### Technical Field

The instant disclosure is related to video enhancement and more specifically to temporal video enhancement.

### Background

Current deep learning is utilized in video enhancement techniques such as denoising, super resolution, style transfer, color transformation and high-dynamic range (HDR) enhancement based on corresponding image processing tasks. A significant drawback of applying image-based algorithms independently to each video frame is probable flickering, caused by temporal instability of the image-based algorithms. Curing this temporal instability by direct application of these methods to video would most likely require large amounts memory and computational resources.

### SUMMARY

An example method of temporal video enhancement includes receiving a plurality of original video frames, reducing a spatial resolution of the plurality of original video frames to yield a plurality of reduced resolution video frames, extracting at least one temporal feature of the plurality of reduced resolution video frames, spatially modeling the plurality of original video frames based on the at least one temporal feature to output a plurality of temporally stable video frames and merging the plurality of temporally stable video frames.

Another example method of temporal video enhancement includes receiving a plurality of original video frames, reducing a spatial resolution of the plurality of original video frames to yield a plurality of reduced resolution video frames, enhancing the plurality of reduced resolution video frames to yield a plurality of enhanced video frames, extracting at least one temporal feature of the plurality of reduced resolution video frames, spatially modeling the plurality of original video frames based on the at least one temporal feature and the plurality of enhanced video frames to output a plurality of temporally stable video frames and merging the plurality of temporally stable video frames.

Yet another example method of temporal video enhancement includes receiving a plurality of original video frames, reducing a spatial resolution of the plurality of original video frames to yield a plurality of reduced resolution video frames extracting at least one temporal feature of the plurality of reduced resolution video frames, upsampling the at least one temporal feature and concatenating the upsampled at least one temporal feature with the plurality of original video frames.

### DESCRIPTION OF THE DRAWINGS

In the drawings:

FIG. 1 is a first exam system diagram in accordance with one embodiment of the disclosure;

FIG. 2 is a second example system diagram in accordance with one embodiment of the disclosure;

FIG. 3 is an example flow of temporal video enhancement in accordance with one embodiment of the disclosure;

FIG. 4 is an example method of temporal video enhancement in accordance with one embodiment of the disclosure;

FIG. 5 is a second example method of temporal video enhancement in accordance with one embodiment of the disclosure; and

FIG. 6 is a third example method of temporal video enhancement in accordance with one embodiment of the disclosure.

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus may be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

Flickering may be perceived by a viewer as an abrupt changed in the tone or brightness of a video frame within a video. A video is comprised of multiple video frames shown in time sequence. Individual video frames are image frames.

Current image enhancement techniques treat individual video frames as image frames in isolation. The image enhancement performed on one individual frame may differ from the enhancement performed on a neighboring frame, this may lead to differential image treatment that may be perceived as flickering in a video.

An original video frame in one example may be an unenhanced as recorded, i.e. original video frame. The original video frame in this example would be a full resolution video frame.

The spatial resolution of the unenhanced original video frame may be reduced, such as from high definition (HD) to standard definition (SD) which reduces the number of displayed pixels. This reduction in spatial resolution has the effect of reducing the number of stored pixels for a given image frame and reduces the bandwidth required to send or process the image frame.

Features of an image in frames from related scenes may be dependent upon one another, for instance, the frames may share similar exposure levels and color tones within the same scene. This frame-to-frame set of exposure levels and color tones in one example would define the set of temporal features for those frames, such that a temporal model may be constructed. Extraction of the temporal features may be performed on reduced resolution video frames to reduce the memory bandwidth and computation resources to perform the extraction.

The spatial model of a video frame in one example may include image-based algorithms, such as denoising, super resolution, style transfer, high-dynamic range and color enhancement for the image frames that make up the video. In this disclosure, video frames and image frames may be considered equivalent, as a video is comprised of multiple video or equivalently image frames.

The instant application proposes combining a set of temporal features from a set of reduced resolution video frames and matching those temporal features in those frames to the original video frames. The matched frames would then be enhanced utilizing the temporal features for those frames as a guide in the enhancement process. This may provide image-based algorithms a possible solution to temporal consistency in the resulting video.

Temporal features and spatial features may be determined utilizing a reduced resolution video sequence to output temporally stable frames. Instead of relying on post-processing methods to reduce flickering of the processed video, the image-based algorithm may be trained to directly output frames that are temporally consistent. In this disclosure the terms temporal information and temporal features may be considered equivalent and the terms spatial information and spatial features may be considered equivalent.

In one example the extraction of the temporal features may be performed on the video sequence at a lower spatial resolution to conserve memory and processing bandwidth.

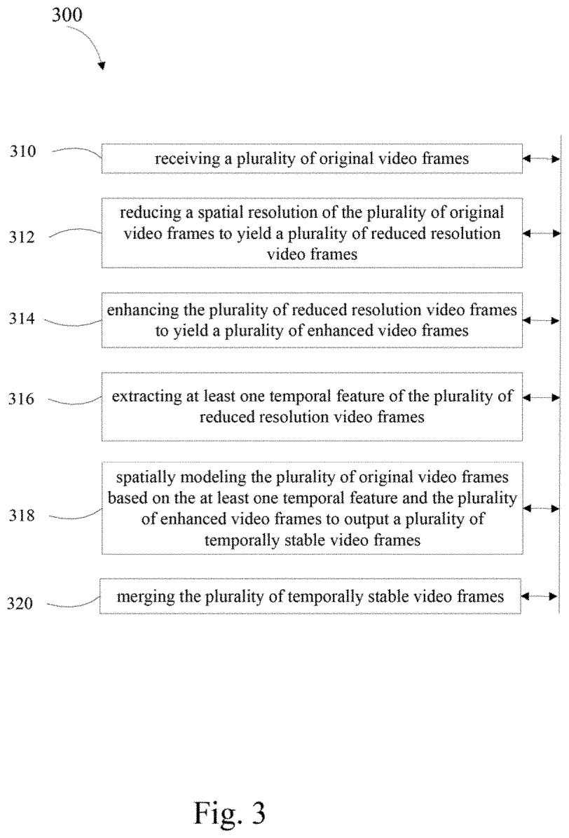

One example of the approach is shown in FIG. 3. A temporal module may process the video to extract the temporal features. To reduce memory and computing bandwidth, the spatial resolution of the video may be reduced for extracting the temporal features. A spatial model may perform image-based algorithms, such as denoising, super resolution, high-dynamic range, color enhancement and the like, on the full resolution frames in the video. The spatial model may utilize the extracted temporal features as a guide so that the resulting in a video that may have reduced flickering when the output frames are combined.

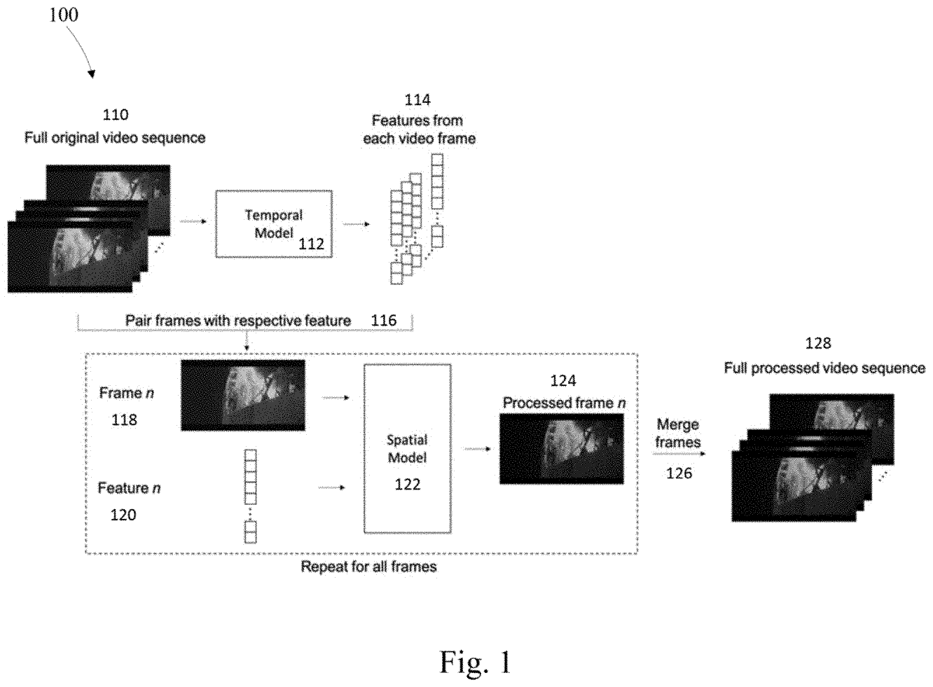

FIG. 1 depicts a first example flow 100. In this example a full resolution original video sequence 110 is input. A temporal model of a reduced spatial resolution video sequence is determined 112 and at least one output of the model is a set of temporal features 114 from the video frames of the reduced spatial resolution video sequence. A pairing 116 is performed between the set of temporal features for video image n 120 and the full resolution video image frame 118. A spatial model 122 of the paired frames and respective features of the full resolution frame is constructed and outputs processed video frame n 124. The processed video frames are merged 126 to yield a full resolution video sequence 128 that is temporally stable.

One task in the proposed solution may be to extract temporal features from the is video. The capture of temporal features may allow visual continuity frame-to-frame from related scenes, which are visually dependent upon one other. For example, the exposure levels and color tones of frames within the same scene should be consistent. Without sufficient information from neighboring frames, the resulting output frames produced by the processing algorithm may be unstable, which may lead to video flickering. Thus, given the original video sequence, a model may be trained to provides features which would serve as a temporal guide to the spatial model.

Possible models that may be utilized to extract temporal information include a 3D convolutional neural network (CNN). Unlike 2D CNNs which perform spatial convolution operations, this network structure may perform the convolution operation over an additional dimension to extract both temporal and spatial features from the sequence. In one example video frames may be combined in the third dimension utilizing the temporal and spatial features. If the network has a sufficient receptive field, it may fully cover the video and output features which consider information from the entire video sequence.

Another possible model may involve a recurrent neural network (RNN) in which internal states are used for remembering the past and the outputs that are influenced by the prior inputs. This is accomplished using a loop in the neural network where prior information may be passed forward. The model may also process an input sequence of variable length yielding resulting features that may contain temporal information from the entire video sequence.

Another consideration may be the model's memory consumption and computational complexity. If the full resolution video sequence is utilized in each operation, the processing unit may utilize increased computational resources. One example approach may be to reduce the spatial resolution of video frames before inputting to the model. The tradeoff in using a reduced spatial resolution method to reduce the computational resource on the output quality of the model may be minimal. This is because the reduced resolution video may be used to extract temporal features, while the spatial model may be performed on the original frames in full resolution.

One example method may directly train the temporal model to execute the video enhancement task at a lower resolution. The input and output videos of the model may be spatially downsized with the latter being an enhanced version such as a denoised, super resolution of the input. Temporal information may be determined, and the resulting video may be temporally stable. By using the resulting frames as the temporal feature for their corresponding input frame, the spatial model would have a small-scale targeted output as a guide.

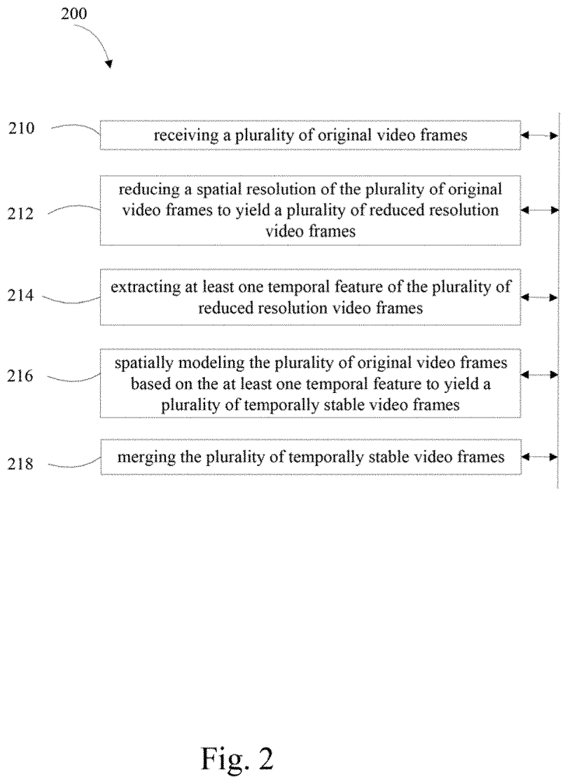

FIG. 2 depicts a method of temporal video enhancement 200, including, receiving 210 a plurality of original video frames, reducing 212 a spatial resolution of the plurality of original video frames to yield a plurality of reduced resolution video frames and extracting 214 at least one temporal feature of the plurality of reduced resolution video frames. The model includes spatially modeling 216 the plurality of original video frames based on the at least one temporal feature to output a plurality of temporally stable video frames and merging 218 the plurality of temporally stable video frames.

The method may also include temporally modeling the plurality of reduced resolution video frames, pairing the plurality of original video frames with the at least one temporal feature and training the spatial modeling to output temporally stable video frames in real-time.

The method may also extract the temporal feature utilizing a neural network, where the neural network is at least one of a three-dimensional convolutional neural network and a recurrent neural network. The spatial modeling may utilize a neural network where the extracting of the at least one temporal feature utilizes a set of information from a neighboring reduced resolution video frame and the set of information includes at least one of and exposure level and a color tone. The extracting of the temporal feature may be based on intermediate features and or concatenated with at least one higher level feature.

Instead of using the resulting output frames, one example may include the use of intermediate features of the model as the temporal features. For instance, in RNN, internal states are used to keep track of histories, which this case would be information from neighboring frames. The corresponding states used as prior information for the output of the video frames in the temporal model may be used as a guide for the spatial model. The temporal model may be trained to do the processing task on the video sequence at a lower spatial resolution. From the trained model, temporal features may be extracted for the use by the spatial model. These features may be the final output of the model, feature maps from the intermediate layers or a combination of both.

With reference to the temporal features obtained from the previous step, these features may be utilized in implementation of image-based deep learning methods on individual video frames. Neural networks may be utilized for denoising, super resolution, and HDR enhancement, If spatial modeling is applied to process video frames individually, the final output of the models may be independent of information their respective neighboring frames. Without temporal feature information, the spatial model has difficulty in deciding on the best output. For instance, if only one frame is considered, determination of whether this image should be adjusted to have higher or lower illumination to be consistent to the video would not be possible. If the decision is informed by information from neighboring frames, the model may determine the overall exposure level of the video for the most consistent results and provide a more reliable output. Therefore, in addition to using the original video frame as input, the model has access to corresponding features obtained from the previous temporal model. These temporal features inform the spatial model of a general baseline of the output.

There are several possible approaches to incorporate temporal features into a spatial model. If the resolution of the video frames is reduced, the features extracted may be of higher-level in the spatial domain and may lack low-level features such as edges In this example the temporal feature may be concatenated with features deeper into the current network, where the receptive field is larger, and the features detected are of higher-level.

FIG. 3 depicts a second method of temporal video enhancement 300, including, receiving 310 a plurality of original video frames, reducing 312 a spatial resolution of the plurality of original video frames to yield a plurality of reduced resolution video frames and enhancing 314 the plurality of reduced resolution video frames to yield a plurality of enhanced video frames. The model also includes extracting 316 at least one temporal feature of the plurality of reduced resolution video frames, spatially 318 modeling the plurality of original video frames based on the at least one temporal feature and the plurality of enhanced video frames to output a plurality of temporally stable video frames and merging 320 the plurality of temporally stable video frames.

The method may include extracting of the at least one temporal feature utilizing a neural network where the neural network is either a three-dimensional convolutional neural network or a recurrent neural network and the extracting the temporal feature utilizing information from neighboring reduced resolution video frames.

Another example of combining temporal feature information into the spatial model may include upsampling the features of the original resolution. This may allow direct matching of the temporal feature information to the spatial model which does not downsize the features and has no features with matching dimensions at the lower resolution in this example, instead of concatenating with higher-level features in model, a directly concatenation the upsampled temporal feature may be performed with the corresponding original frames.

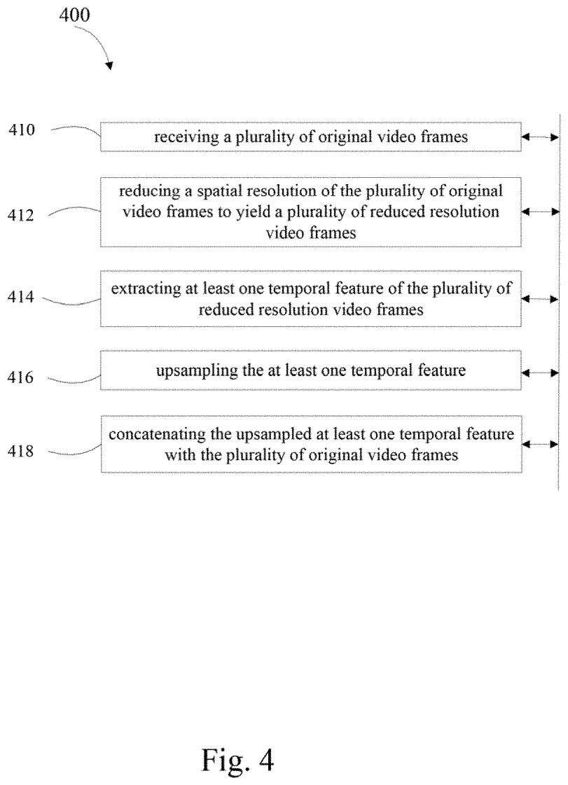

FIG. 4 depicts a third method of temporal video enhancement 400, including, receiving 410 a plurality of original video frames, reducing 412 a spatial resolution of the plurality of original video frames to yield a plurality of reduced resolution video frames and extracting 414 at least one temporal feature of the plurality of reduced resolution video frames. The method includes upsampling 416 the at least one temporal feature and concatenating 418 the upsampled at least one temporal feature with the plurality of original video frames.

The method may include extracting of the at least one temporal feature utilizing a neural network where the neural network is either a three-dimensional convolutional neural network or a recurrent neural network and the extracting the temporal feature utilizing information from neighboring reduced resolution video frames.

The proposed method may allow image-based algorithms to directly output frames that are temporally consistent, with the model being adjusted for temporal feature information, This extraction of corresponding temporal features for video frames, may be modeled at a lower spatial resolution to utilize less computational and memory resources.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the system. Skilled artisans may implement the described functionality in varying ways for each particular application. Various components and blocks may be arranged differently (e.g., arranged in a different order, or partitioned in a different way) without departing from the scope of the subject technology.

it is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects may be readily apparent to those skilled in the art, and the generic principles defined herein may be applied to other aspects. Thus, the claims are not intended to be limited to the aspects shown herein but is to be accorded the full scope consistent with the language claims wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation, or a component ma also mean the processor being programmed to monitor and control the operation or the processor being operable to monitor and control the operation. Likewise, a processor configured to execute code may be construed as a processor programmed to execute code or operable to execute code.

A phrase such as an “aspect” does not imply that such aspect is essential to the subject technology or that such aspect applies to configurations of the subject technology. A disclosure relating to an aspect may apply to configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to configurations of the subject technology. A disclosure relating to an embodiment may apply to embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to configurations of the subject technology. A disclosure relating to a configuration may apply to configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

Structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art may be able to design and incorporate any one of the variety of mechanisms suitable for accomplishing the above-described functionalities.

It is to be understood that the disclosure teaches just one example of the illustrative embodiment and that many variations of the invention may easily be devised by those skilled in the art after reading this disclosure and that the scope of then present invention is to be determined by the following claims.

What is claimed is:

1. A method of temporal video enhancement, comprising:
receiving a plurality of original video frames;
reducing a spatial resolution of the plurality of original video frames to yield a plurality of reduced resolution video frames;
extracting at least one temporal feature of the plurality of reduced resolution video frames;
spatially modeling the plurality of original video frames based on the at least one temporal feature to output a plurality of temporally stable video frames; and
merging the plurality of temporally stable video frames.

2. The method of temporal video enhancement of claim 1, further comprising:
temporally modeling the plurality of reduced resolution video frames.

3. The method of temporal video enhancement of claim 1, further comprising pairing the plurality of original video frames with the at least one temporal feature.

4. The method of temporal video enhancement of claim 1, further comprising:
training the spatial modeling to output temporally stable video frames.

5. The method of temporal video enhancement of claim 1, wherein:
the extracting of the at least one temporal feature is performed by a neural network.

6. The method of temporal video enhancement of claim 5, wherein:
the neural network is at least one of a three dimensional convolutional neural network and a recurrent neural network.

7. The method of temporal video enhancement of claim 1, wherein:
the spatial modeling is performed by a neural network.

8. The method of temporal video enhancement of claim 1, wherein:
the extracting of the at least one temporal feature utilizes a set of information from at least one neighboring reduced resolution video frames.

9. The method of temporal video enhancement of claim 8, wherein:
the set of information includes at least one of and exposure level and a color tone.

10. The method of temporal video enhancement of claim 1, wherein:
the extracting of the at least one temporal feature is based on intermediate features.

11. The method of temporal video enhancement of claim 1, wherein:
the extracting of the at least one temporal feature is concatenated with at least one higher level feature.

12. A method of temporal video enhancement, comprising:
receiving a plurality of original video frames;
reducing a spatial resolution of the plurality of original video frames to yield a plurality of reduced resolution video frames;
enhancing the plurality of reduced resolution video frames to yield a plurality of enhanced video frames;
extracting at least one temporal feature of the plurality of reduced resolution video frames;
spatially modeling the plurality of original video frames based on the at least one temporal feature and the plurality of enhanced video frames to output a plurality of temporally stable video frames; and
merging the plurality of temporally stable video frames.

13. The method of temporal video enhancement of claim 12, wherein:
the extracting of the at least one temporal feature is performed by a neural network.

14. The method of temporal video enhancement of claim 1, wherein:
the neural network is at least one of a three dimensional convolutional neural network and a recurrent neural network.

15. The method of temporal video enhancement of claim 12, wherein:
the extracting of the at least one temporal feature utilizes a set of information from at least one neighboring reduced resolution video frames.

16. A method of temporal video enhancement, comprising:
receiving a plurality of original video frames;
reducing a spatial resolution of the plurality of original video frames to yield a plurality of reduced resolution video frames;
extracting at least one temporal feature of the plurality of reduced resolution video frames;
upsampling the at least one temporal feature; and
concatenating the a sampled at least one temporal feature with the plurality of original video frames.

17. The method of temporal video enhancement of claim 16, wherein:
the extracting of the at least one temporal feature is performed by a neural network.

18. The method of temporal video enhancement of claim 17, wherein:
the neural network is at least one of a three dimensional convolutional neural network and a recurrent neural network.

19. The method of temporal video enhancement of claim 16, wherein:
the extracting of the at least one temporal feature utilizes a set of information from at least one neighboring reduced resolution video frames.
